(19) United States
(12) Patent Application Publication
(10) Pub. No.: US 2013/0301826 A1
(43) Pub. Date: Nov. 14, 2013

(54) SYSTEM, METHOD, AND PROGRAM FOR PROTECTING CRYPTOGRAPHIC ALGORITHMS FROM SIDE-CHANNEL ATTACKS

(71) Applicants: Shay GUERON, Haifa (IL); Vlad KRASNOV, Nesher (IL)

(72) Inventors: Shay GUERON, Haifa (IL); Vlad KRASNOV, Nesher (IL)

(73) Assignee: INTEL CORPORATION, Santa Clara, CA (US)

(21) Appl. No.: 13/466,444

(22) Filed: May 8, 2012

(51) Int. Cl. H04L 9/28

(52) U.S. Cl. 380/28

(57) ABSTRACT

A system for protecting algorithms from side-channel attacks includes a digital processor having a first register, a second register, and a third register; an execution unit; and a processing unit. The execution unit executes an iterative loop for computing a value of a variable and sets a value of the first register based on either an operation or an instruction (or both) within the iterative loop. The processing unit stores the computed value of the variable in the second register and stores a predefined constant in the third register. Side-channel protection may also be provided by a method, a processor, and a program stored on a computer-readable medium.

### FIELD OF THE INVENTION

The present disclosure pertains to the field of processing logic, microprocessors, and associated instruction set architecture that, when executed by the processor or other processing logic, perform logical, mathematical, or other functional operations. More specifically, the present disclosure relates to systems, methods, and programs for side-channel-protected implementation of one or more steps in an algorithm, particularly those algorithms having cryptographic applications.

### BACKGROUND

Over the past two decades, the uses and availability of the Internet have increased rapidly. This rapid expansion of the Internet's application brought with it an ever-increasing need for greater end-to-end security. In turn, this growing demand for security further burdens the computational load of servers supporting secure communications, such as Transport Layer Security (TLS) and Secure Sockets Layer (SSL), which use cryptographic algorithms to facilitate the secure transfer of information across the World Wide Web. As the demand for further security increased, so did the complexity of these algorithms. Accordingly, the cryptographic algorithms used in communications security protocols have become a key target for optimization.

An important consideration in optimizing these algorithms is the prevention of side-channel attacks. These attacks exploit the ability of an outside attacker to learn about the inner workings of a security algorithm by recognizing that different inputs would cause the algorithm to behave differently, such as by taking more time or consuming more power to implement the process. For example, a spy code running parallel to code implementing a cryptographic algorithm may be able to infer the branches and memory-access patterns of the cryptographic code, thus allowing the spy to infer secret information and compromising the code's security.

Certain steps in many cryptographic algorithms remain vulnerable to side-channel attacks, and any new cryptographic algorithm must balance the need for secure, side-channel-protected processing with computational efficiency. In the context of public key algorithms such as RSA, for example, modular exponentiation is used, wherein the exponent, base, and modulus are secret.

Thus, there remains a need for a computationally-efficient means of side-channel-protected implementation of cryptographic algorithms.

### BRIEF DESCRIPTION OF THE DRAWINGS

Embodiments of the present invention will become more fully understood from the following detailed description and its accompanying drawings. These drawings are given by way of illustration only and do not limit the disclosed embodiments of the present invention. The drawings provided with this application are as follows:

FIG. 1 is a block diagram of an exemplary computing system that performs algorithms in accordance with certain embodiments;

FIG. 2 shows an example process for protecting an algorithm from side-channel attacks, in accordance with certain embodiments;

FIG. 3 shows an example system for protecting an algorithm from side-channel attacks, in accordance with certain embodiments;

FIG. 4 shows another example process for protecting an algorithm from side-channel attacks, in accordance with certain embodiments; and

FIG. 5 shows another example system for protecting an algorithm from side-channel attacks, in accordance with certain embodiments.

### DETAILED DESCRIPTION

Certain embodiments of the present invention generally relate to systems, methods, and programs for side-channel-protected implementation of one or more steps in an algorithm, such as those with cryptographic applications. One object of certain embodiments of the present invention is to implement cryptographic algorithms with greater computational efficiency while simultaneously protecting against side-channel attacks/analysis.

A first embodiment of the present invention is a system for protecting an algorithm from side-channel attacks. In certain embodiments, this system includes a digital processor having a first register, a second register, and a third register; an execution unit; and a processing unit. The execution unit may be programmed to execute an iterative loop for computing a value of a variable and to set a value of the first register based on one of an operation and an instruction within the iterative loop. The processing unit may be programmed to store the computed value of the variable in the second register and to store a predefined constant in the third register. Alternative embodiments may further include a multiplication unit and a subtraction unit. The multiplication unit may be programmed to multiply the value in the third register by the value in the first register, and the subtraction unit may be programmed to subtract the value in the third register from the value in the second register.

A second embodiment of the present invention is a method for protecting an algorithm from side-channel attacks. This method may include executing an iterative loop for computing a value of a variable; setting a value of a first register of a digital processor based on one of an operation and instruction within the iterative loop; storing the computed value of the variable in a second register of the digital processor; and storing a predefined constant in a third register of the digital processor. Alternative embodiments may further include multiplying the value in the third register by the value in the first register and subtracting the value in the third register from the value in the second register.

A third embodiment of the present invention is a processor. In certain embodiments, this processor includes memory having a first register, and an execution unit. The execution unit may be programmed to execute an iterative loop for computing a value of a variable and to set a value of the first register based on one of an operation and instruction within the iterative loop. Alternative embodiments may further include a processing unit, a multiplication unit, and a subtraction unit. The processing unit may be programmed to store the computed value of the variable in a second register of the memory and/or to store a predefined constant in a third register of the memory. The multiplication unit may be programmed to multiply the value in the third register by the value in the first register, and the subtraction unit may be programmed to subtract the value in the third register from the value in the second register.

A fourth embodiment of the present application is a non-transitory computer-readable medium storing a program for protecting an algorithm from side-channel attacks, such that when executed by a processor the program performs a method comprising the following: executing an iterative loop for computing a value of a variable, setting a value of a first register of a digital processor based on one of an operation and instruction within the iterative loop, storing the computed value of the variable in a second register of the digital processor, and storing a predefined constant in a third register of the digital processor. Alternative embodiments may further include multiplying the value in the third register by the value in the first register, and subtracting the value in the third register from the value in the second register.

The disclosed embodiments of the invention may be embodied in numerous devices and through numerous methods, systems, and apparatuses. The following detailed description, taken in conjunction with the corresponding drawings, discloses specific, non-limiting examples. Other embodiments, which incorporate some, all, or more of the features taught herein, are also possible.

The systems, methods, and programs discussed herein may be applied to any algorithm or software implementation, not just those having cryptographic applications.

In the following description, numerous specific details such as processing logic, processor types, micro-architectural conditions, events, enablement mechanisms, and the like are set forth in order to provide a more thorough understanding of embodiments of the present invention. It will be appreciated, however, by one skilled in the art that the invention may be practiced without such specific details. Additionally, some well known structures, circuits, and the like have not been shown in detail to avoid unnecessarily obscuring embodiments of the present invention.

One embodiment of the present invention may provide a single core or multi-core processor. The processor may be coupled to a storage device that stores an application program. The application program when executed by the processor may perform a SHA digest computation method using SIMD instructions. The method may comprise receiving a message that includes a plurality of bits, preprocessing the message according to a selected SHA algorithm to generate a plurality of message blocks and generating hash values for every n message blocks as long as there are n or more message blocks left. The hash values may be generated by preparing message schedules in parallel using SIMD instructions and performing compression in serial for the respective n message blocks. The number n may be determined based on the SIMD register width and the selected SHA algorithm's word size. The method may further comprise generating hash values for any remaining message blocks by preparing message schedules and performing compression for the remaining message blocks in serial, and generating a message digest conforming to the selected SHA algorithm.

Although the following embodiments are described with reference to a processor, other embodiments are applicable to other types of integrated circuits and logic devices. Similar techniques and teachings of embodiments of the present invention can be applied to other types of circuits or semiconductor devices that can benefit from higher pipeline throughput and improved performance. The teachings of embodiments of the present invention are applicable to any processor or machine that performs data manipulations. However, the present invention is not limited to processors or machines that perform 1024 bit, 512 bit, 256 bit, 128 bit, 64 bit, 32 bit, or 16 bit data operations and can be applied to any processor and machine in which manipulation or management of data is performed.

Although the below examples describe instruction handling and distribution in the context of execution units and logic circuits, other embodiments of the present invention can be accomplished by way of a data or instructions stored on a machine-readable, tangible medium, which when performed by a machine cause the machine to perform functions consistent with at least one embodiment of the invention. In one embodiment, functions associated with embodiments of the present invention are embodied in machine-executable instructions. The instructions can be used to cause a general-purpose or special-purpose processor that is programmed with the instructions to perform the steps of the present invention. Embodiments of the present invention may be provided as a computer program product or software which may include a machine or computer-readable medium having stored thereon instructions which may be used to program a computer (or other electronic devices) to perform one or more operations according to embodiments of the present invention. Alternatively, steps of embodiments of the present invention might be performed by specific hardware components that contain fixed-function logic for performing the steps, or by any combination of programmed computer components and fixed-function hardware components.

Instructions used to program logic to perform embodiments of the invention can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer). The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, assembly language, machine code, or the like.

Scientific, financial, auto-vectorized general purpose, RMS (recognition, mining, and synthesis), and visual and multimedia applications (e.g., 2D/3D graphics, image processing, video compression/decompression, voice recognition algorithms and audio manipulation) may require the same operation to be performed on a large number of data items. In one embodiment, Single Instruction Multiple Data (SIMD) refers to a type of instruction that causes a processor to perform an operation on multiple data elements. SIMD technology may be used in processors that can logically divide the bits in a register into a number of fixed-sized or variable-sized data elements, each of which represents a separate value. For example, in one embodiment, the bits in a 256-bit register may be organized as a source operand containing four separate 64-bit data elements, each of which represents a separate 64-bit value. In another embodiment, the bits in a 512-bit register may be organized as a source operand containing eight separate 64-bit data elements, each of which represents a separate 64-bit value. This type of data may be referred to as ‘packed’ data type or ‘vector’ data type, and operands of this data type are referred to as packed data operands or vector operands. In one embodiment, a packed data item or vector may be a sequence of packed data elements stored within a single register, and a packed data operand or a vector operand may be a source or destination operand of a SIMD instruction (or ‘packed data instruction’ or a ‘vector instruction’). In one embodiment, a SIMD instruction specifies a single vector operation to be performed on two source vector operands to generate a destination vector operand (also referred to as a result vector operand) of the same or different size, with the same or different number of data elements, and in the same or different data element order.

SIMD technology, such as that employed by the Intel® Core™ processors having an instruction set including x86, MMX™, Streaming SIMD Extensions (SSE), SSE2, SSE3, SSE4.1, SSE4.2, Advanced Vector Extensions (AVX), AVX2 and AVX3 instructions, ARM processors, such as the ARM Cortex® family of processors having an instruction set including the Vector Floating Point (VFP) and/or NEON instructions, and MIPS processors, such as the Loongson family of processors developed by the Institute of Computing Technology (ICT) of the Chinese Academy of Sciences, has enabled a significant improvement in application performance (Core™ and MMX™ are registered trademarks or trademarks of Intel Corporation of Santa Clara, Calif.).

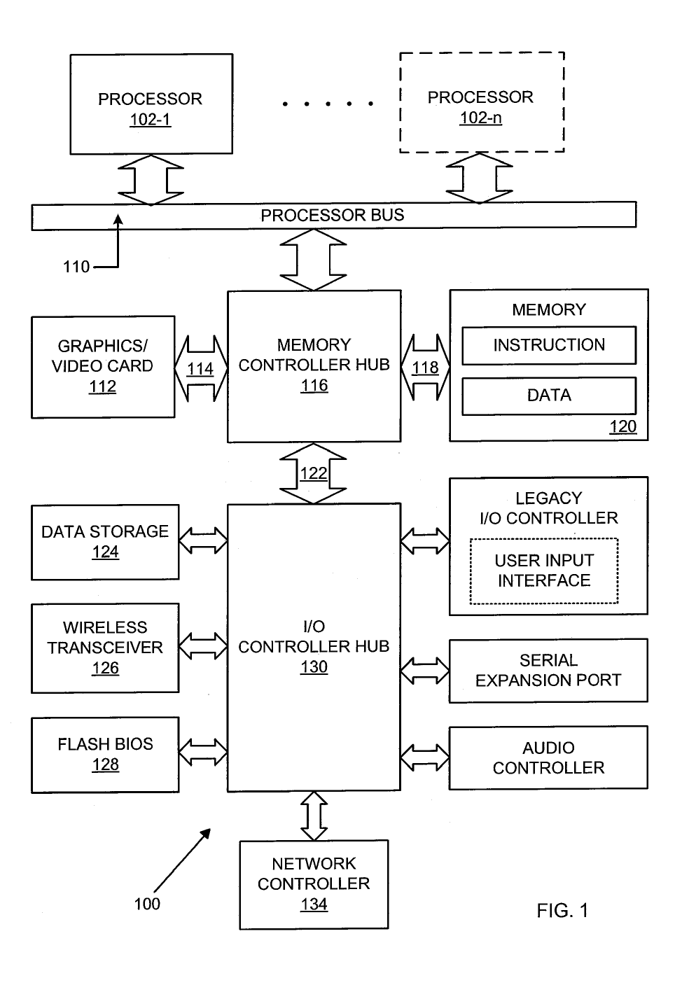

FIG. 1 is a block diagram of an exemplary computing system 100. System 100 includes a component, such as a processor 102.1 to employ execution units including logic to perform algorithms for process data, in accordance with the present invention, such as in the embodiment described herein. System 100 is representative of processing systems based on the PENTIUM® III, PENTIUM® 4, Xeon™, Itanium®, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 100 may execute a version of the WINDOWS™ operating system available from Microsoft Corporation of Redmond, Wash., although other operating systems (UNIX and Linux for example), embedded software, and/or graphical user interfaces, may also be used. Thus, embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

One embodiment of the system 100 may be described in the context of a single processor desktop or server system, but alternative embodiments can be included in a multiprocessor system. System 100 may be an example of a ‘hub’ system architecture. The computing system 100 may include one processor 102.1 (or optionally a plurality of processors 102.1˜102.n, n being an integer larger than one) to process data signals. The processor 102.1 may be a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 102.1 may be coupled to a processor bus 110 that can transmit data signals between the processor 102.1 and other components in the system 100. The elements of system 100 perform their conventional functions that are well known to those familiar with the art.

Depending on the architecture, the processor 102.1 can have a single internal cache or multiple levels of internal cache. Alternatively, in another embodiment, the cache memory can reside external to the processor 102.1. Other embodiments can also include a combination of both internal and external caches depending on the particular implementation and needs. In one embodiment, the processor 102.1 may include multiple level of caches (e.g., level 1, level 2, etc.). In one embodiment, the processor 102.1 may be implemented in one or more semiconductor chips. When implemented in one chip, all or some of the processor 102.1's components may be integrated in one semiconductor die.

The processor 102.1 may include register files (not shown) that can store different types of data in various registers including integer registers, floating point registers, status registers, and instruction pointer register. The processor 102.1 may also include a microcode (ucode) ROM that stores microcode for certain macroinstructions. For one embodiment, the processor 102.1 may include logic to handle a packed instruction set (not shown). By including the packed instruction set in the instruction set of a general-purpose processor 102.1, along with associated circuitry to execute the instructions, the operations used by many multimedia applications may be performed using packed data in a general-purpose processor 102.1. Thus, many multimedia applications can be accelerated and executed more efficiently by using the full width of a processor's data bus for performing operations on packed data. This can eliminate the need to transfer smaller units of data across the processor's data bus to perform one or more operations one data element at a time.

Alternate embodiments of the processor 102.1 can also be used in micro controllers, embedded processors, graphics devices, DSPs, and other types of logic circuits. System 100 includes a memory 120. Memory 120 can be a dynamic random access memory (DRAM) device, a static random access memory (SRAM) device, flash memory device, or other memory device. Memory 120 can store instructions and/or data represented by data signals that can be executed by the processor 102.1.

A system logic chip 116 is coupled to the processor bus 110 and memory 120. The system logic chip 116 in the illustrated embodiment is a memory controller hub (MCH). The processor 102.1 can communicate to the MCH 116 via a processor bus 110. The MCH 116 provides a high bandwidth memory path 118 to memory 120 for instruction and data storage and for storage of graphics commands, data and textures. The MCH 116 is to direct data signals between the processor 102.1, memory 120, and other components in the system 100 and to bridge the data signals between processor bus 110, memory 120, and system I/O 122. In some embodiments, the system logic chip 116 can provide a graphics port for coupling to a graphics controller 112. The MCH 116 is coupled to memory 120 through a memory interface 118. The graphics card 112 is coupled to the MCH 116 through an Accelerated Graphics Port (AGP) interconnect 114.

System 100 may use a hub interface bus 122 to couple the MCH 116 to the I/O controller hub (ICH) 130. The ICH 130 provides direct connections to some I/O devices via a local I/O bus. The local I/O bus is a high-speed I/O bus for connecting peripherals to the memory 120, chipset, and processor 102.1. Some examples are the audio controller, firmware hub (flash BIOS) 128, wireless transceiver 126, data storage 124, legacy I/O controller containing user input and keyboard interfaces, a serial expansion port such as Universal Serial Bus (USB), and a network controller 134. The data storage device 124 can comprise a hard disk drive, a floppy disk drive, a CD-ROM device, a flash memory device, or other mass storage device.

For another embodiment of a system, an instruction in accordance with one embodiment can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight or more SIMD registers for packed data. For the discussions below, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) and 256 bits wide YMM registers relating to AVX or AVX3 technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

Certain embodiments of the present invention solve the problem of software implementation of modular exponentiation in a manner that is side-channel protected. As one example, an implementation may be side-channel protected when the implementation does not reveal inner workings of the underlying algorithm simply by observing variations in the algorithm caused by variations of the input. For example, an implementation is side-channel protected when knowing the branches and the memory-access patterns of the underlying algorithm does not reveal information the designer of the algorithm wishes to keep secret.

These implementations may be particularly important in software implementing cryptographic algorithms. For example, a spy code running in parallel to a code implementing a cryptographic algorithm can infer the branches and the memory-access patterns of the cryptographic code. These spying techniques are generally referred to as “side-channel attacks.”

In particular, certain embodiments of the present invention implement code that is “inherently protected” against side-channel attacks. In this context, a piece of code is inherently protected against software side-channel attacks if, for a chosen input, volunteering the full details of the following items does not leak sensitive information: (1) the memory addresses that were accessed by read and/or write commands; (2) the resolutions of the executed branches (that is, which path was taken at a particular branch); and (3) the executed instructions.

Certain embodiments of the present invention relate to an inherently protected modular exponentiation implementation that helps mitigate side-channel attacks. In particular, certain embodiments of the present invention relate to public key cryptographic algorithms, such as RSA, that use modular exponentiation wherein the exponent, the base, and the modulus are secret.

One way to implement modular exponentiation is based on Montgomery multiplication (MM). An example definition and algorithm for performing MM follows.

Let m (the modulus) be an odd integer. Further, let a and b be two positive integers such that 0≦a and b<m. Let t be another positive integer. Then, the Montgomery Multiplication of a by b, modulo m, with respect to t, is defined as MM (a, b)=a×b×2⁻⁴ mod m. Here, t is called the Montgomery parameter.

Algorithm 1 (“Word-by-Word MM”)

| | |
|---|---|
| Input: | m < 2ⁿ, 0 ≦ a, b < m, n = s × k |
| Output: | a × b × 2⁻ⁿ mod m |
| Pre-Computed: | k0 = −m⁻¹ mod 2^{s} |
| Flow: | |

```
      1. T = a × b
      For i = 1 to k, do
            2. T1 = T mod 2^{s}
            3. Y = T1 × k0 mod 2^{s}
            4. T2 = Y × m
            5. T3 = (T + T2)
            6. T = T3 / 2^{s}
      End For
      7. If T ≧ m, then X = T − m;
            else X = T
      Return X
```

The value of s may be determined based on the architecture on which the above algorithm is implemented. For example, in a 64-bit architecture, s=64. In an RSA with a 1024-bit key, for example, the MM would then have an n of 512 (512=n=s×k=64×8).

Another example algorithm for implementing MM follows. We refer to this as an “Almost Montgomery multiplication” (AMM). Throughout this specification and the claims, references to MM or Montgomery multiplication include Almost Montgomery multiplication as well, unless otherwise noted.

Algorithm 2 (“Word-by-Word AMM”)

| Input: | m < 2ⁿ, 0 ≦ a, b < 2ⁿ, n = s × k |
|---|---|
| Output: | a × b × 2⁻ⁿ mod m |
| Pre-Computed: | k0 = −m⁻¹ mod 2^{s} |
| Flow: | |
| 1. T = a × b | |
| For i = 1 to k, do | |
| 2. T1 = T mod 2^{s} | |
| 3. Y = T1 × k0 mod 2^{s} | |
| 4. T2 = Y × m | |
| 5. T3 = (T + T2) | |
| 6. T = T3 / 2^{s} | |
| End For | |
| 7. If T ≧ 2ⁿ, then X = T − m; | |
| else X = T | |
| Return X | |
| Post Condition: | X mod m = a × b × 2⁻ⁿ mod m, and X < 2ⁿ |

AMM offers the following advantages over conventional MM. First, the post condition of AMM does not guarantee that the result is a fully reduced modulo m. Second, step 7 of Algorithm 2 has a different condition check: T≧2ⁿ compared to T≦m. And third, at the end of step 6 of Algorithm 2, it is easy to know whether subtraction (at step 7) is needed based on the carry-out bit of steps 5 and 6.

In Algorithms 1 and 2, step 7 is referred to as an End Reduction (ER) step. This ER step is a conditional subtraction step that is preferably kept side-channel protected. Otherwise, if an outside party knows whether the subtraction took place when implementing the MM/AMM, this party could infer information about the inner workings of the algorithm, thus compromising the overall cryptography of the implementation. For this reason, the ER step is preferably carried out in a side-channel protected way. In other words, this branch (the conditional subtraction of the ER step) should be hidden, and the memory-access pattern should not disclose whether the subtraction took place. Accordingly, certain embodiments of the present invention provide more efficient, side-channel-protected software implementation of MM (and AMM) in general and of step 7 (the ER step) in particular.

One embodiment of the present invention addresses a side-channel-protected implementation of step 7 (the ER step) of Algorithms 1 and 2. One way to side-channel protect an implementation of this sort is to make execution time independent of the ER steps. This implies that the subtraction (in this case, T−m) always takes place. For Algorithms 1 and 2, for example, this might be accomplished by subtracting either 0 or m from T, depending on T's value. By always performing the subtraction step, there is no branch in the implementation; the subtraction of the ER step always occurs because either m or 0 is subtracted from the result (T) of step 6. Therefore, the memory-access patterns of the flow are independent of the values of T and m. Thus, a spy code could not determine any information about T or m based on the memory-access patterns or computation time.

Under normal execution of Algorithm 2, for example, the decision whether subtraction needs to take place is based on whether T≧2ⁿ. Instead of performing a conditional subtraction, which would make the ER step vulnerable to side-channel attacks, a property of T can determine whether to output a value of T or T−m. In Algorithm 2, this can be determined by the carry-out bit of the last addition step (step 5) of the iterative loop.

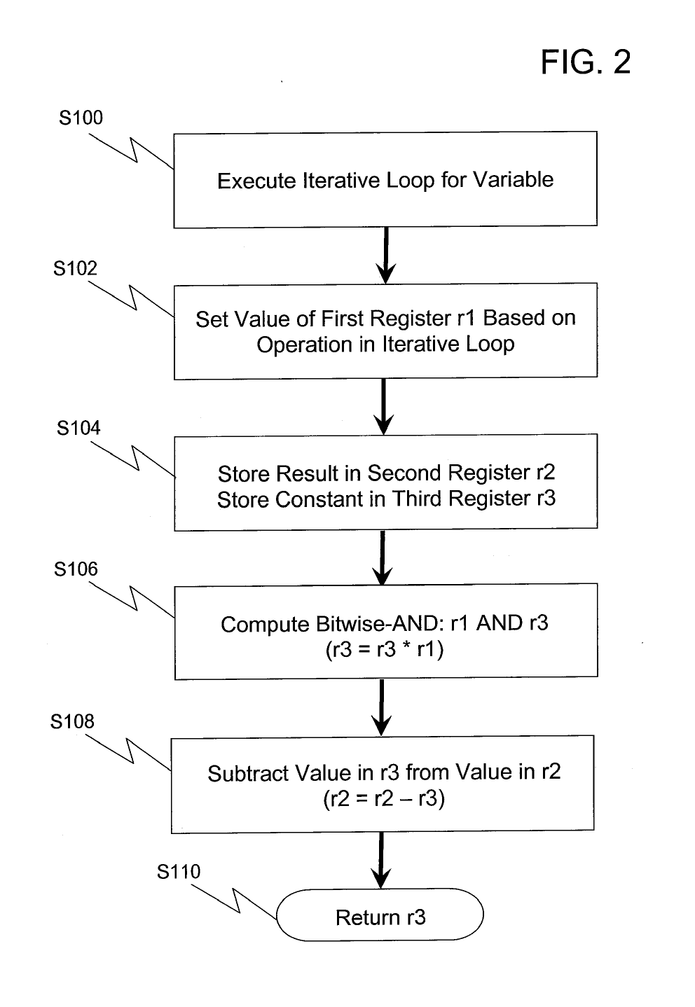

One example method for protecting an algorithm from side-channel attacks is shown in FIG. 2. In step S100, an iterative loop is executed to compute a value of a variable T. In certain embodiments, the iterative loop may be the for loop shown in steps 2-6 in Algorithms 1 and 2. However, any type of iterative loop may be used in place of this for loop. Non-limiting examples include an if loop, a while loop, and the like.

The iterative loop may undergo one or more iterations of one or more mathematical operations or programming instructions to compute iterative values of a variable. Though specific operations are shown in Algorithms 1 and 2, any number and type of mathematical, programming, or data manipulation operations may serve as the iterative loop. Preferably, the iterative loop includes at least one addition operation, such as that shown in step 5 of Algorithms 1 and 2.

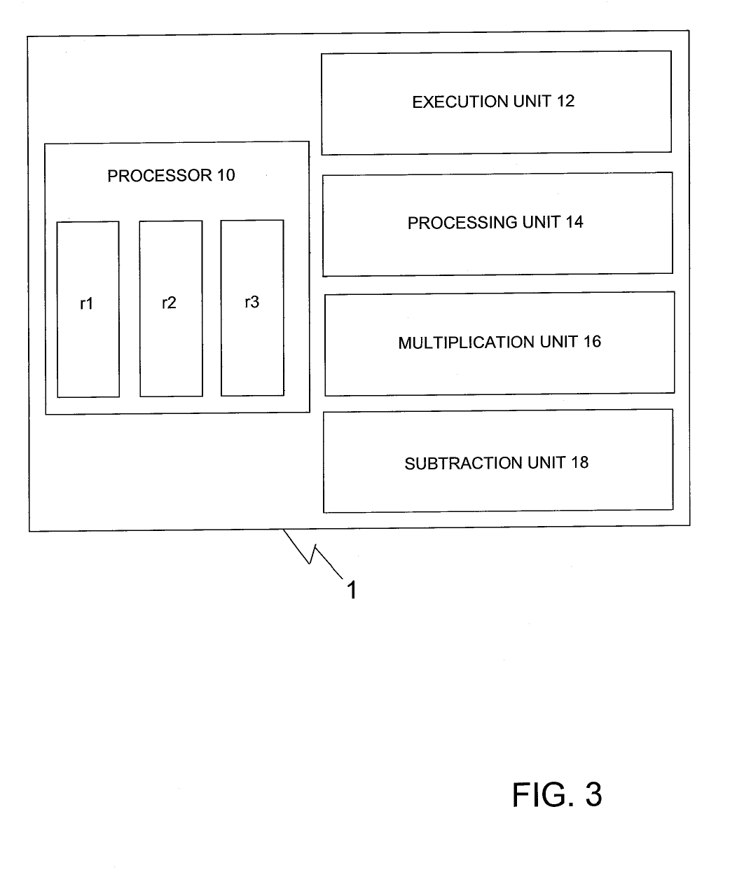

Next, at step S102 in FIG. 2, the value of a first register r1 (of processor 10 in FIG. 3, for example) is set based on an operation/instruction within the iterative loop executed in step S100. For example, the carry-out bit from one of the operations in the iterative loop can be used to determine a value to store in register r1. More specifically, the carry-out bit from the last-computed step 5 of Algorithms 1 or 2 may be used to determine a value to store in register r1. In this example, r1 will hold 1 if there was a carry out and 0 if there was no carry out.

After the iterative loop of step S100 completes, the final computed value of variable T (the result) is stored at step S104 in a second register r2 (of processor 10, for example). In certain embodiments, a Qword (of s-bits) of the result (T) is stored in second register r2.

Also at step S104, a predefined constant is stored in a third register r3 (of processor 10, for example). The timing of this second portion of step S104 is not limited, however, and the step of storing a predefined constant in a third register may occur at any time before, during, or after execution of the iterative loop of step S100. In preferred embodiments, the predefined constant is the modulus (m) of a Montgomery or Almost Montgomery multiplication. In certain embodiments, a Qword (of s-bits) of the predefined constant is stored in third register r3.

At the conclusion of step S104 in the present embodiment, the registers hold the following values:
r1: either 1 or 0 (depending on carry out)
r2: T
r3: m

At step S106, the bitwise-AND of registers r1 and r3 is computed, with the result stored in r3. Thus, depending on the carry-out bit from the iterative loop, r3 will hold either 0 or the predefined constant (m in this example) at the end of step S106.

After step S106, the value in register r3 is subtracted from the value in register r2 at step S108, with the result stored in register r2. This subtraction may be a subtract-with-borrow (sbb) instruction. Thus, at the conclusion of step S108, register r2 holds either a value of the result of the iterative loop (T) or this result minus the predefined constant (e.g., modulus m), depending on the carry out of an operation within the iterative loop of step S100. At step S110, the value in register r2 is moved to memory or otherwise output in accordance with the requirements of the overall algorithm.

This process effectively subtracts either 0 or a predefined constant from the result of the iterative loop, as required by the ER step of Algorithms 1 and 2, for example. However, there is no branch in this implementation: the subtraction in the ER step is always performed, not conditionally performed. Moreover, the memory access patterns are the same for every execution and are independent of the values of T and m. Thus, this process is side-channel protected.

In certain embodiments, a Qword (of s-bits) of the result (T) of the iterative loop is stored in register r2, and a Qword (of s-bits) of the predefined constant (e.g., modulus m) is stored in third register r3. In this example, register r1 would store a value of 2^{s}—carry-out bit (using an sbb instruction for example). Here, s may be the bit number of the processor (such as 64, 128, etc.).

In certain embodiments, a carry flag (CARRY) may be generated by an operation in the iterative loop as one example basis for determining the value stored in register r1. For example, the addition in step 5 of Algorithm 1 or 2 (T3=T+T2) may generate CARRY during the last iteration of the for loop. Thus, at the end of step 5 of the last iteration of the loop, a carry-out bit from the last addition is obtained. Then, using an sbb instruction, the value in register r1 may be computed based on the following: r1←r1—CARRY. This sets the value in register r1 to either 2^{s}−1 if there was a carry out in step 5 (i.e., CARRY=1), or to 0 if there was no carry out (i.e., CARRY=0). Next, a Qword (s-bits) of the result (T) of the iterative loop is loaded into register r2, and a Qword (s-bits) of the predefined constant (e.g., modulus m) is loaded into register r3. Like the previous embodiment, this implementation subtracts either the predefined constant (in the case of CARRY=0) or 0 (in the case of CARRY=1) from the result of the iterative loop, as required by the ER steps of Algorithm 1 and 2.

The following example code (in Intel syntax of x86 assembly language) shows how this process may be implemented for AMM for 512-bit operands. Note, however, that other specific implementations of this process will be readily apparent to those of skill in the art upon reviewing the teachings of this specification, and the following example in no way limits the various embodiments of the present invention.

# rcx holds zero
# carry flag holds carry out from the last adc operation of iterative loop
# rbx points to the result (T)
# rsi points to the modulus (m)

| | |
|---|---|
| sbbq %rcx, %rcx | # subtract the carry flag from rcx |
| | # if set: rcx = 1\hat{ }64 (1), otherwise: |
| | rcx = 0\hat{ }64 (0) |
| movq (%rsi), %r8 | # load the modulus |
| movq 8(%rsi), %r9 | |
| movq 16(%rsi), %r10 | |
| movq 24(%rsi), %r11 | |
| movq 32(%rsi), %r12 | |
| movq 40(%rsi), %r13 | |
| movq 48(%rsi), %r14 | |
| movq 56(%rsi), %r15 | |
| andq %rcx, %r8 | # the AND nullifies the modulus if there was |
| | no carry; |
| andq %rcx, %r9 | # that is, if carry = 0, then r8 - r15 |
| | (now storing the modulus) will |
| andq %rcx, %r10 | # also be made 0 by the bitwise-AND operation |
| andq %rcx, %r11 | |
| andq %rcx, %r12 | |
| andq %rcx, %r13 | |
| andq %rcx, %r14 | |
| andq %rcx, %r15 | |
| subq %r8, (%rbx) | # subtract from the result |
| sbbq %r9, 8(%rbx) | # if there was no carry, zero is subtracted; |
| | otherwise |
| sbbq %r10, 16(%rbx) | # the modulus is subtracted |
| sbbq %r11, 24(%rbx) | |
| sbbq %r12, 32(%rbx) | |
| sbbq %r13, 40(%rbx) | |
| sbbq %r14, 48(%rbx) | |
| sbbq %r15, 56(%rbx) | |

In this implementation, no branches are used. Moreover, the memory-access patterns are independent of the carry-out bit. In other words, the same memory access pattern is used regardless of the carry-out bit. Additionally, the memory access patterns of the flow are independent of the values of T and m. Thus, this implementation is inherently protected from side-channel attacks.

Systems for side-channel-protected implementation of cryptographic algorithms can be implemented by a digital computer having specialized programming and structure suitable to carry out the previously described embodiments. For example, this system could include a central processing unit (CPU), RAM functioning as a work area of the CPU, an external storage device (such as a hard disk), a reader for reading data from a storage medium (such as a CD-ROM, a flash drive, or other memory), an input device (such as a keyboard and/or mouse), a display unit (such as a liquid crystal display), a communication unit for communicating with another apparatus through a network (such as the Internet or a local access network), and an interface for sending and receiving data between these components.

One example system for carrying out side-channel protected implementations is shown in FIG. 3. This system 1 includes a processor 10, an execution unit 12, a processing unit 14, a multiplication unit 16, and a subtraction unit 18. In other embodiments, components 10-18 may be included in two or more systems interconnected through a network.

Processor 10 includes a plurality of registers (memory), including register r1, register r2, and register r3. This processor may be, for example, a digital processor or a CPU such as an Intel® Core™ processor (available from Intel Corporation).

The step of executing an iterative loop may be carried out by execution unit 12 or by means for executing an iterative loop. Preferably, the execution unit and executing means will have suitable programming (or other configurations) sufficient to carry out the step of executing an iterative loop that iteratively computes values of a variable, as described herein. In certain embodiments, execution unit 12 (or the executing means) may be a subroutine. In other embodiments, execution unit 12 may be a specially programmed device configured to carry out the functions described herein. This device may be part of a CPU or separate therefrom. In certain embodiments, execution unit 12 is incorporated as part of processor 10.

The step of storing a computed value of a variable in a second register and storing a predefined constant in a third register may be carried out by processing unit 14 or by means for storing values in specified registers/memory. Preferably, processing unit 14 and the storing means will have suitable programming (or other configurations) sufficient to carry out the step of storing a computed value and a predefined constant in specified registers, as described herein. In certain embodiments, processing unit 14 (or the storing means) may be a subroutine. In other embodiments, processing unit 14 (or the storing means) may be a specially programmed device configured to carry out the functions described herein. This device may be part of a CPU or separate therefrom.

The step of multiplying the value in the third register by the value in the first register (the bitwise-AND instruction step) may be carried out by multiplication unit 16 or by means for multiplying. Preferably, the multiplication unit (and multiplying means) will have suitable programming (or other configurations) sufficient to carry out the step of multiplying a value in a specified register by a value in another register or for carrying out a bitwise-AND instruction, as described herein. In certain embodiments, multiplication unit 16 (or the multiplying means) may be a subroutine. In other embodiments, multiplication unit 16 (or the multiplying means) may be a specially programmed device configured to carry out the functions described herein. This device may be part of a CPU or separate therefrom.

The step of subtracting the value in the third register from the value in the second register may be carried out by subtraction unit 18 or by or means for subtracting. Preferably, subtraction unit 18 and subtracting means will have suitable programming (or other configurations) sufficient to carry out the step of subtracting (such as by an sbb instruction) a value in a specified register from a value in another register, as described herein. In some embodiments, subtraction unit 18 (or the subtracting means) may be a subroutine. In other embodiments, subtraction unit 18 (or the subtracting means) may be a specially programmed device configured to carry out the functions described herein. This device may be part of a CPU or separate therefrom.

Although the above embodiments are best suited for use in the side-channel protection of AMM, they may also be employed to MM as well. However, the following embodiments may be preferably used with MM.

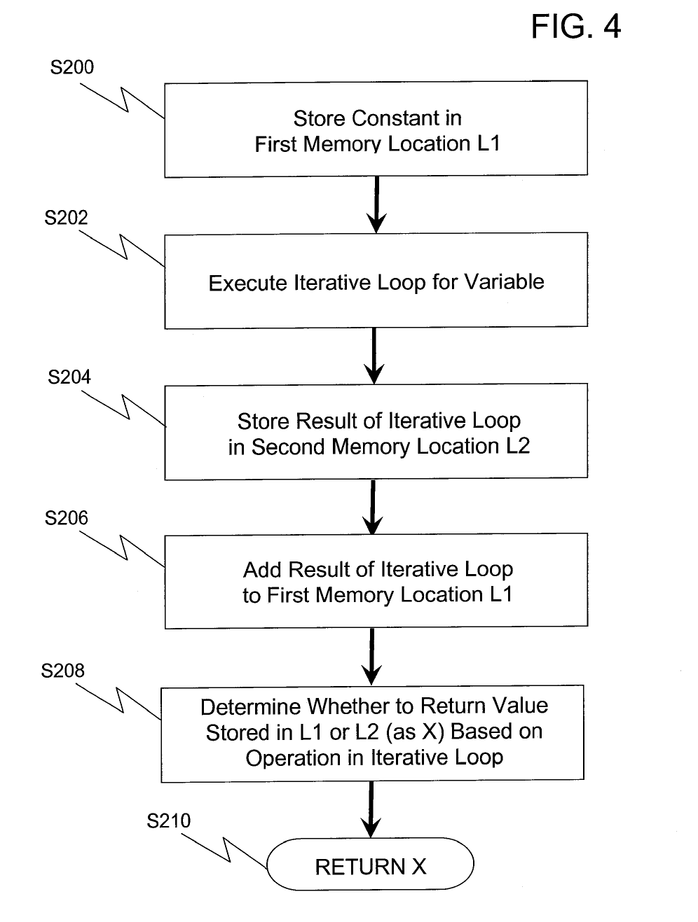

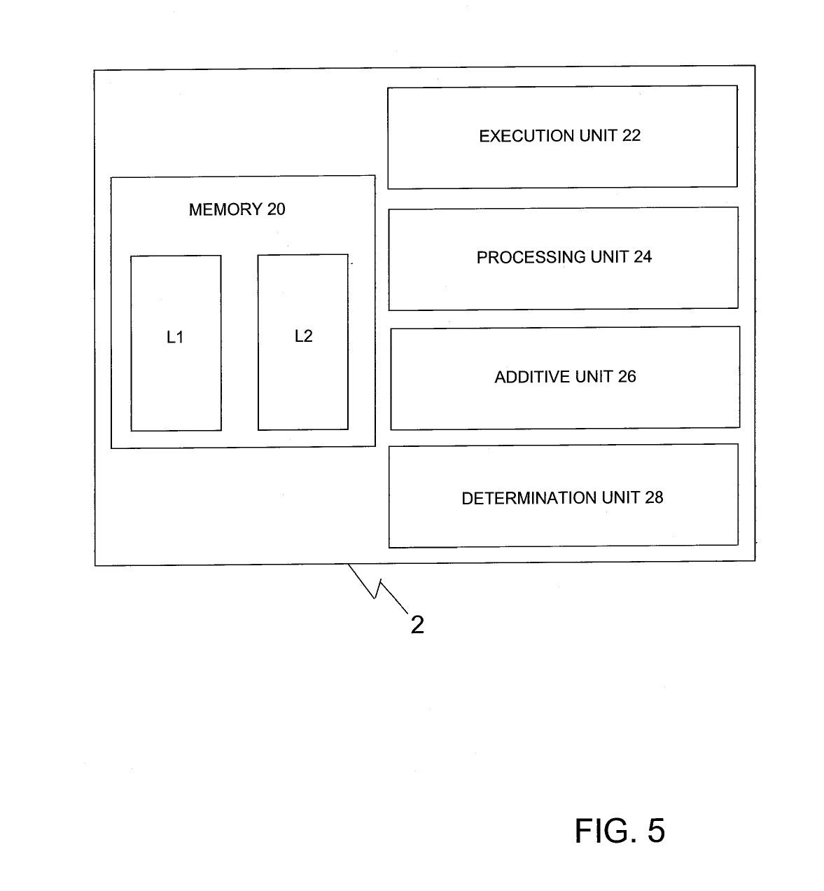

FIG. 4 depicts an example process for side-channel protection of the MM in Algorithm 1. Initially, as shown in step S200, a constant, pre-defined value (which may be a modulus −m) is stored in a first memory location L1 (shown as part of memory 20 in FIG. 5). In certain embodiments, the predefined value is a constant and is more preferably a modulus of a MM or AMM.

Next, in step S202, an iterative loop is executed iteratively to output a value of a variable T. In certain embodiments, the iterative loop may be the for loop shown in steps 2-6 in Algorithm 1. However, the present invention is not so limited, and any type of iterative loop may be used in place of a for loop. Non-limiting examples include an if loop, a while loop, and the like. The iterative loop may undergo one or more iterations of one or more mathematical operations or programming instructions to compute iterative values of a variable. Though specific operations are shown in Algorithm 1, the present embodiment is not so limited, and any number and type of operations or instructions may serve as the iterative loop of the present invention. Preferably, the iterative loop includes at least one addition operation.

After the iterative loop of step S202 completes, the computed value of the variable (the result) is stored at step S204 in a second memory location L2 (shown in FIG. 5). In certain embodiments, the computed value is the result of the iterative loop performed at step S202.

At step S206, the computed value of the result (T) is added to first memory location L1, which stores the predefined constant (for example, modulus −m). Thus, in the present example, first memory location L1 stores a value of T−m after completion of step S206.

In certain embodiments, steps S204 and S206 may occur in reverse order. In other embodiments, these steps may occur simultaneously. In still other embodiments, steps S204 and S206 may be carried out as a single step or by a single unit with suitable programming.

At the completion of steps S204 and S206 in this example, first memory location L1 holds the value T−m, while second memory location L2 holds the value T. Accordingly, the subtraction of the ER step (in this embodiment T−m) is always performed. By always performing the ER step, an outside party learns no secret information about the algorithm at the ER step, as it would have if the ER step were conditionally performed. Using this implementation, the ER step is protected from side-channel attacks that may determine the base, modulus, or exponent of the MM based on whether the subtraction occurs. Because the subtraction always occurs, the ER step is side-channel protected against branch analysis or similar attacks.

In step S208, it is determined which memory location holds the desired output. In one example, the carry out-bit of the last addition in the for loop determines which of the two memory locations to query for the output. For example, if the carry-out bit is 1, then subtraction is required, and the memory location holding T−m (e.g., memory location L1) will be queried for its value. Otherwise, (e.g., if the carry-out bit is 0), the memory location holding T (e.g., memory location L2) will be queried for its value.

Finally, in step S210, the value stored in either memory location L1 or memory location L2 is output/returned in accordance with the requirements of the overall algorithm to be side-channel protected. The output occurs in accordance with the determination made in step S208. Thus, if it is determined in steps S208 that the value in memory location L1 should be output, the value in that location is output at this step.

In this implementation, there is no if operation in the ER step, and thus no branch from which an adverse party can determine secret information about the algorithm. Additionally, the memory access is independent of the values of T and m.

The following example code (in Intel syntax of x86 assembly language) shows how this process may be implemented for MM for 512-bit operands. Other specific implementations of this process will be readily apparent to those of skill in the art upon reviewing the teachings of this specification, and the following example in no way limits the various embodiments of the present invention.

# rcx and rax hold zero
# carry flag holds carry out from the last adc
# rbx points to the result
# rsi points to the modulus (−m)
sbbq %rcx, %rcx

| | |
|---|---|
| movq %r8, (%rbx) | # load the result T into GPRs |
| movq %r9, 8(%rbx) | |
| movq %10, 16(%rbx) | |
| movq %11, 24(%rbx) | |
| movq %12, 32(%rbx) | |
| movq %13, 40(%rbx) | |
| movq %14, 48(%rbx) | |
| movq %r15, 56(%rbx) | |
| addq (%rsi) %r8 | # add −m to the result in register |
| adcq 8 (%rbp), %r9 | |
| adcq 16(%rbp), %r10 | |
| adcq 24(%rbp), %r11 | |
| adcq 32(%rbp), %r12 | |
| adcq 40(%rbp), %r13 | |
| adcq 48(%rbp), %r14 | |
| adcq 56(%rbp), %r15 | |
| sbbq %rax, %rax | # if there was carry out, then the addition was |
| | unneeded |
| | # and rax is set to 0 |
| orq %rax, %rcx | # if either rax or rcx is 0, rax stores a value of 0 |
| movq (%rbx), %rax | # conditionally load the unmodified |
| cmove %rax, %r8 | # result based on the carry flag |
| movq 8 (%rbx), %rdx | |
| cmove %rdx, %r9 | |
| ... | |
| movq 56 (%rbx), %rdx | |
| cmove %rdx, %r15 | |
| movq %r8, (%rbx) | # store the correct result |
| movq %r9, 8 (%rbx) | |
| ... | |
| movq %r15, 56 (%rbx) | |

This example implementation does not require pre-computing of a large table of values; nor does it require storing such a table for the duration of the exponentiation.

As shown in FIG. 5, memory 20 including first memory location L1 and second memory location L2, an execution unit 22, a processing unit 24, an additive unit 26, and a determination unit 28 may be included in a single system 2. In other embodiments, components 20-28 may be included in two or more systems interconnected through a network.

Memory 20 maybe any type of computer-readable medium capable of storing digital information. Non-limiting examples include floppy disks, optical disks, and CD/DVD-ROMs. This memory may include any volatile, non-volatile, fixed, removable, magnetic, optical, or electrical media, such as RAM (random access memory), ROM (read-only memory), CD-ROM, hard disk drives, a magnetic disk recording medium, memory cards or sticks, NVRAM, EEPROM, flash memory, and any other suitable computer-readable medium known to those of ordinary skill in the art.

Memory 20, including the first and second memory locations, may be located within the same computing environment as the side-channel-protected algorithm (that is, within the same system for protecting the algorithm from side-channel attacks/analyses). Additionally, the memory could be located in a separate environment, either in physically or digitally, from the algorithm. For example, the memory could be located on a remote server, a host computer, or the computing device of an end-user, such as a laptop, personal computer, cell phone, tablet, or any other digital device.

The step of executing an iterative loop (step S202) may be carried out by execution unit 22 or by means for executing an iterative loop. Preferably, the execution unit and executing means will have suitable programming (or other configurations) sufficient to carry out the step of executing an iterative loop that iteratively computes values of a variable, as described herein. In certain embodiments, execution unit 22 (or the executing means) may be a subroutine. In other embodiments, execution unit 22 may be a specially programmed device configured to carry out the functions described herein. This device may be part of a CPU or separate therefrom.

The steps of storing a predefined constant in a first memory location and storing a computed result in a second memory location (steps S200 and S204, respectively) may be carried out by processing unit 24 or by means for storing values in specified memory locations. Preferably, processing unit 24 and the storing means will have suitable programming (or other configurations) sufficient to carry out the steps S200 and S204 as described herein. In certain embodiments, processing unit 24 (or the storing means) may be a subroutine. In other embodiments, processing unit 24 (or the storing means) may be a specially programmed device configured to carry out the functions described herein. This device may be part of a CPU or separate therefrom. The processing unit or processing means may also have programming suitable for carrying out the output of step S210.

The step of adding a determined value to a first memory location (step S206) may be carried out by additive unit 26 or by means for adding. Preferably, additive unit 26 and the adding means will have suitable programming (or other configurations) sufficient to carry out the step 5206 as described herein. In certain embodiments, additive unit 26 (or the adding means) may be a subroutine. In other embodiments, additive unit 26 (or the adding means) may be a specially programmed device configured to carry out the functions described herein. This device may be part of a CPU or separate therefrom.

The step of determining a memory location holding a desired output based on an operation or instruction within the iterative loop (step S208) may be carried out by determination unit 28 or by means for determining Preferably, determination unit 28 and the determining means will have suitable programming (or other configurations) sufficient to carry out the step S208 as described herein. In certain embodiments, determination unit 28 (or the determining means) may be a subroutine. In other embodiments, determination unit 28 (or the determining means) may be a specially programmed device configured to carry out the functions described herein. This device may be part of a CPU or separate therefrom. The determination unit or determining means may also have programming suitable for carrying out the output of step S210.

In addition to the various units and means described previously, steps S200-S208 of the present embodiment may be carried out using a single processor or means for processing having programming (or other configurations) suitable to carry out the steps described in the present embodiment.

Although specific examples of certain embodiments have been described in the context of optimizing the conditional subtraction of a Montgomery multiplication, the present invention is not so limited. The skilled artisan will recognize, upon review of the present specification, that the previously described algorithms may be applied to any situation where one needs to compute a conditional subtraction. Indeed, these algorithms may even be applied to any conditional operation or instruction.

Various embodiments of the present invention may be implemented using any type of electronic control device, such as a microprocessor or computer specially programmed according to the teachings of the disclosed embodiments. Certain embodiments of the present invention thus also include a machine- or computer-readable medium, which may include instructions used to program a processor to perform a method according to certain embodiments of the present invention. Preferably, certain embodiments of the present invention are provided on x86-64 architectures, such as those provided by Intel Corporation.

Embodiments of the mechanisms disclosed herein may be implemented in hardware, software, firmware, or a combination of these implementation approaches. Embodiments of the invention may be implemented as computer programs or program code executing on programmable systems comprising at least one processor, a storage system (including volatile and non-volatile memory and/or storage elements), at least one input device, and at least one output device.

Program code may be applied to input instructions to perform the functions described herein and generate output information. The output information may be applied to one or more output devices, in known fashion. For purposes of this application, a processing system includes any system that has a processor, such as a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. These representations, known as “IP cores” may be stored on a tangible, machine readable medium and supplied to various customers or manufacturing facilities to load into the fabrication machines that actually make the logic or processor.

These machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Accordingly, certain embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

While various embodiments have been described, other embodiments are plausible. The foregoing descriptions of various examples of systems, methods, and programs for protecting algorithms from side-channel attacks are not limiting. And any number of modifications, combinations, and alternatives of these examples may be employed to facilitate the effectiveness of protecting algorithms from side-channel attacks.

Numerous other embodiments may be implemented without departing from the spirit and scope of these exemplary embodiments of the present invention. Moreover, while certain features may be shown on only certain embodiments, these features may be exchanged, added, and removed from and between the various embodiments. Likewise, methods described may also be performed in various sequences, with some or all of the disclosed steps being performed in a different order than described.

We claim:

1. A system for protecting an algorithm from side-channel attacks, the system comprising:
a digital processor including a first register, a second register, and a third register;
an execution unit programmed to execute an iterative loop for computing a value of a variable, the execution unit further programmed to set a value of the first register based on one of an operation and an instruction within the iterative loop; and
a processing unit programmed to store the computed value of the variable in the second register, the processing unit further programmed to store a predefined constant in the third register.

2. The system of claim 1, further comprising:
a multiplication unit programmed to multiply the value in the third register by the value in the first register; and
a subtraction unit programmed to subtract the value in the third register from the value in the second register.

3. The system of claim 2, wherein the processing unit is further programmed to move the value in the second register to a location in memory after the subtraction unit subtracts the value in the third register from the value in the second register.

4. The system of claim 1, wherein the operation within the iterative loop includes an addition operation.

5. The system of claim 4, wherein the execution unit is further programmed to set the value of the first register based on a carry-out bit of the most-recent execution of the addition operation.

6. The system of claim 1, wherein the system inherently protects the algorithm from side-channel attacks.

7. The system of claim 1, wherein the algorithm is a cryptographic algorithm.

8. The system of claim 1, wherein the predefined constant is a modulus of a Montgomery multiplication.

9. A method for protecting an algorithm from side-channel attacks, the method comprising:
executing an iterative loop for computing a value of a variable;
setting a value of a first register of a digital processor based on one of an operation and an instruction within the iterative loop;
storing the computed value of the variable in a second register of the digital processor; and
storing a predefined constant in a third register of the digital processor.

10. The method of claim 9, further comprising:
multiplying the value in the third register by the value in the first register; and
subtracting the value in the third register from the value in the second register.

11. The method of claim 10, further comprising moving the value in the second register to a location in memory after the subtracting the value in the third register from the value in the second register.

12. The method of claim 9, wherein the operation within the iterative loop includes an addition operation.

13. The method of claim 12, further comprising setting the value of the first register based on a carry-out bit of the most-recent execution of the addition operation.

14. The method of claim 9, wherein the method inherently protects the algorithm from side-channel attacks.

15. The method of claim 9, wherein the algorithm is a cryptographic algorithm

16. The method of claim 9, wherein the predefined constant is a modulus of a Montgomery multiplication.

17. A processor, comprising:
memory including a first register; and
an execution unit programmed to execute an iterative loop for computing a value of a variable and to set a value of the first register based on one of an operation and an instruction within the iterative loop.

18. The processor of claim 17, further comprising a processing unit programmed to store the computed value of the variable in a second register of the memory.

19. The processor of claim 18, wherein the processing unit is further programmed to store a predefined constant in a third register of the memory.

20. The processor of claim 19, further comprising:
a multiplication unit programmed to multiply the value in the third register by the value in the first register; and
a subtraction unit programmed to subtract the value in the third register from the value in the second register.

21. The processor of claim 20, wherein the processing unit is further programmed to output the value in the second register after the subtraction unit subtracts the value in the third register from the value in the second register.

22. The processor of claim 19, wherein the predefined constant is a modulus of a Montgomery multiplication.

23. The processor of claim 17, wherein the operation within the iterative loop includes an addition operation.

24. The processor of claim 23, wherein the execution unit is further programmed to set the value of the first register based on a carry-out bit of the most-recent execution of the addition operation.

25. A non-transitory computer-readable medium storing a program for protecting an algorithm from side-channel attacks, such that when executed by a processor the program performs a method comprising:
executing an iterative loop for computing a value of a variable;
setting a value of a first register of a digital processor based on one of an operation and an instruction within the iterative loop;
storing the computed value of the variable in a second register of the digital processor; and
storing a predefined constant in a third register of the digital processor.

26. The non-transitory computer-readable medium of claim 25, wherein the method further comprises:
multiplying the value in the third register by the value in the first register; and
subtracting the value in the third register from the value in the second register.

27. The non-transitory computer-readable medium of claim 26, wherein the method further comprises moving the value in the second register to a location in memory after the subtracting the value in the third register from the value in the second register.

28. The non-transitory computer-readable medium of claim 25, wherein:
the operation within the iterative loop includes an addition operation; and
the method further comprises setting the value of the first register based on a carry-out bit of the most-recent execution of the addition operation.
